(19) United States
(12) Patent Application Publication
(10) Pub. No.: US 2026/0267644 A1
(43) Pub. Date: Sep. 10, 2026

(54) ASYMMETRIC RISC-V CORES WITH VECTOR EXTENSION (RVV) CLUSTER

(71) Applicant: Infineon Technologies AG, Neubiberg (DE)

(72) Inventors: Muhammad Hassan, München (DE); Thomas Röcker, München (DE); Konrad Walluszik, Wörth (DE); Jürgen Schäfer, Oberhaching (DE)

(21) Appl. No.: 19/542,948

(22) Filed: Feb. 18, 2026

(30) Foreign Application Priority Data
Mar. 6, 2025 (DE) 10 2025 108 471.8

(51) Int. Cl. G06F 9/30

(52) U.S. Cl. CPC G06F 9/30036; G06F 9/30181

(57) ABSTRACT

A microcontroller for performing vector processing tasks and scalar processing tasks using a compute cluster. The compute cluster comprises a plurality of RISC-V cores, at least one of which contains a vector extension and a scalar extension, and at least one of which contains a scalar extension but does not contain a vector extension.

### REFERENCE TO RELATED APPLICATION

This Application claims the benefit of German Application number 10 2025 108 471.8, filed on Mar. 6, 2025, the contents of which are hereby incorporated by reference in their entirety.

### BACKGROUND

The present disclosure relates to a microcontroller comprising a cluster of RISC-V cores, and to the execution of vector processing tasks and scalar processing tasks on said cores.

### BACKGROUND

RISC-V is an open-standard instruction set architecture that follows the Reduced Instruction Set Computing (RISC) approach. RISC-V supports optional extensions that provide additional capabilities, such as a vector extension (RVV) that provides support for vector processing and a scalar extension (RVS) that provides support for scalar processing.

Vector processing and scalar processing have many uses. For example, they are used in the automotive industry to control various functions of a vehicle, including lane keeping assistance, automatic emergency braking and adaptive cruise control. Depending on the criticality of the function for vehicle safety, different Automotive Safety Integrity Levels (ASIL) are enforced. The ASIL standard spans ASIL-A (the lowest standard) to ASIL-D (the highest standard). ASIL-D is enforced for safety critical functions and can be implemented using dual-core lockstep processing. Dual-core lockstep processing is a means of ensuring computational redundancy and requires that a given computational task is performed by two cores to generate two independent results. In other words, the processing task is performed twice, once by each of two cores. The two results can then be compared, with any differences in the two results indicating that a fault has occurred. Dual-core lockstep is not required for lower ASIL standards, such as ASIL-A or ASIL-B compliance.

There is a need to achieve ASIL-D and ASIL-B compliance using RISC-V cores in an efficient way. There is also a need to provide a scalable and area-efficient microcontroller that can perform both vector processing tasks and scalar processing tasks.

### SUMMARY

There is provided a microcontroller comprising a compute cluster, the compute cluster comprising a plurality of RISC-V cores.

The plurality of RISC-V cores comprises at least a first core and a second core. The first core comprises a first scalar extension for performing scalar processing tasks and a first vector extension for performing vector processing tasks. The second core comprises a second scalar extension for performing scalar processing tasks but does not comprise a vector extension. The first core comprises a memory directly accessible by the first scalar extension and the first vector extension, but that is not directly accessible by the second core. The compute cluster comprises an interconnect that connects each core of the plurality of RISC-V cores.

Also provided is a computer implemented method of performing scalar processing tasks and vector processing tasks using the microcontroller.

The method comprises receiving, by the first core, a first scalar processing task and a first vector processing task, performing, by the first scalar extension, the first scalar processing task, and performing, by the first vector extension, the first vector processing task.

Those skilled in the art will recognize additional features and advantages upon reading the following detailed description, and upon viewing the accompanying drawings.

### BRIEF DESCRIPTION OF THE DRAWINGS

The present disclosure is illustrated by way of example, and not by way of limitation, in the figures of the accompanying drawings in which like reference numerals refer to similar or identical elements. The elements of the drawings are not necessarily to scale relative to each other. The features of the various illustrated examples can be combined unless they exclude each other.

FIG. 1 illustrates a microcontroller according to a first example.

FIG. 2 illustrates a microcontroller according to a second example.

FIG. 3 illustrates an example of a scheduling table for the microcontroller of FIG. 2.

FIG. 4 illustrates a second example of a scheduling table for the microcontroller of FIG. 2.

FIG. 5 illustrates an example method for performing scalar processing tasks and vector processing tasks.

FIG. 6 illustrates an exemplary computer system comprising a microcontroller.

### DETAILED DESCRIPTION

The examples described herein provide a microcontroller for performing vector processing tasks and scalar processing tasks.

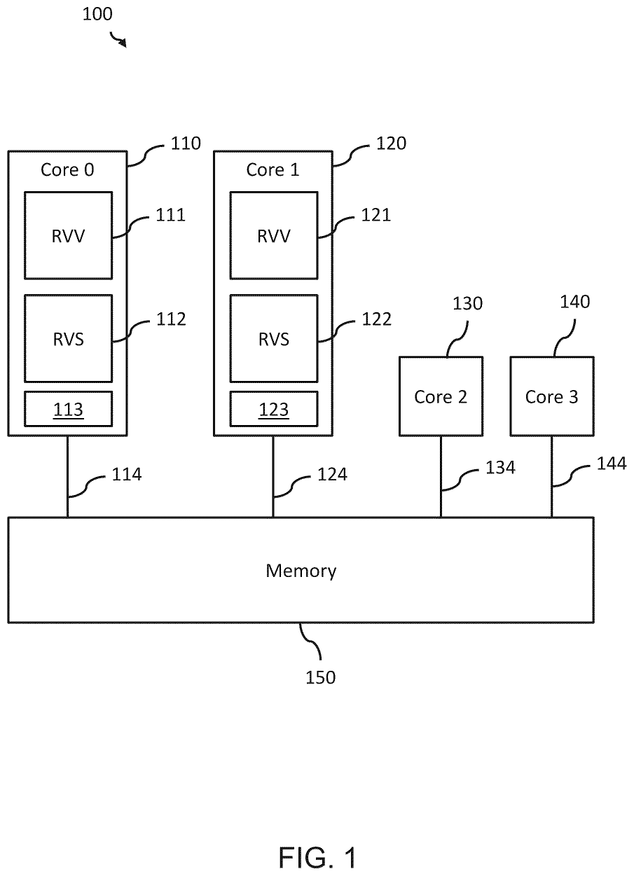

FIG. 1 illustrates an exemplary microcontroller 100 comprising a memory device 150 and a plurality of cores. The microcontroller 100 comprises four cores; however, for simplicity only core 0 110 and core 1 120 are shown in FIG. 1 in detail. Core 0 110 comprises a vector extension (RVV) 111, a scalar extension (RVS) 112 and a plurality of additional components 113 including: a cache; a local memory; a core coupled memory target port; a direct memory access unit; a CPU initiator port; and a core infrastructure comprising a power management unit, an interrupt distribution unit, a safety management unit, a debug unit and a trace unit.

Core 1 120 is identical in structure to core 0 110, comprising a vector extension 121, a scalar extension 122 and additional components 123. More generally, the four cores are identical in that they each comprise the same extensions and additional components. The four cores are each connected to an external memory 150 via independent buses 114, 124, 134, 144. The cores operate independently of one another, being connected only indirectly via the external memory 150.

As each core contains both a scalar extension and a vector extension, each core is able to perform scalar processing tasks and vector processing tasks.

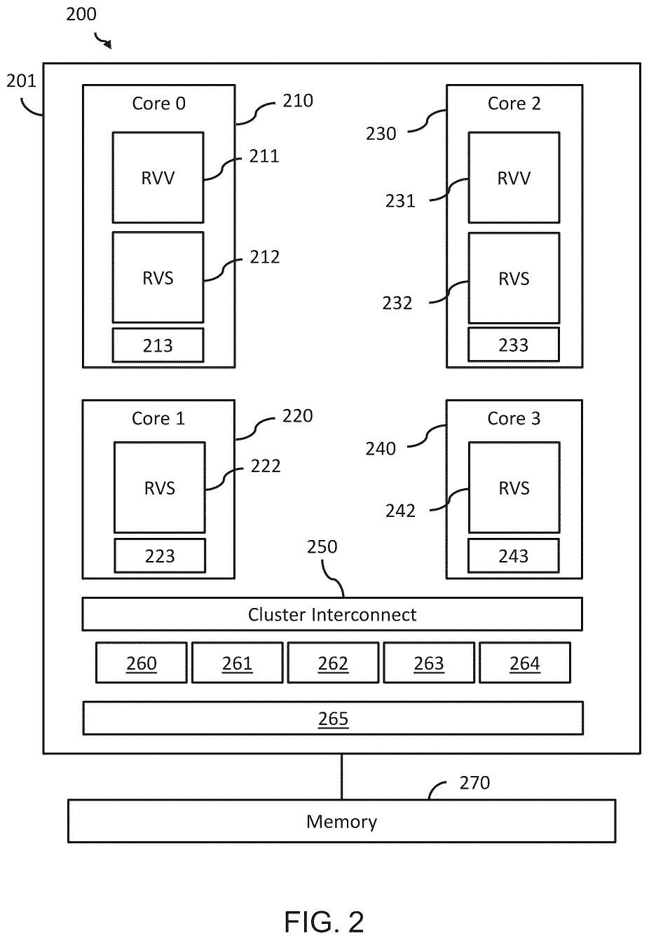

FIG. 2 depicts an example of an improved microcontroller 200 comprising a compute cluster 201 and an external memory 270. Microcontroller 200 also comprises four cores; however, unlike microcontroller 100, only a subset (i.e., not all) of the four cores contain vector extensions. In the illustrated example, only two of the four cores contain vector extensions. More specifically, the core 0 210 comprises a vector extension 211 and a scalar extension 212; core 1 220 comprises a scalar extension 222 but does not contain a vector extension; core 2 230 comprises a vector extension 231 and a scalar extension 232; and core 3 240 comprises a scalar extension 242 but does not contain a vector extension.

Additionally, the four cores of microcontroller have been grouped together to form the compute cluster 201. The cores are connected to each other by a cluster interconnect 250, which allows communication between each of the cores, between the cores and hardware components 260-265 and provides the cores with access to external memory 270. By arranging the cores in a (single) compute cluster, the cores are able to share the use of hardware elements to reduce the footprint of (that is, area needed for) each core. For instance, the cores may be able to share usage of a shared core coupled memory target port 260, a shared cluster cache 261, a shared cluster memory 262, a shared direct memory access unit 263, a shared CPU initiator port 264, and a shared core infrastructure 265. Exemplary components for the shared core infrastructure include a power management unit, an interrupt distribution unit, a safety management unit, a debug unit and a trace unit. Each core is connected to these shared hardware elements via cluster interconnect 250.

Each core also comprises a memory 213, 223, 233, 243 that is only directly accessible by that core. For example, core 0 210 has a local memory 213 that is directly accessible by vector extension 211 and scalar extension 212 but that is not directly accessible by any of the other cores.

As mentioned above, in the illustrated example, only core 0 210 and core 2 230 contain vector extensions, and so only two of the four cores have vector processing capabilities.

Turning back to FIG. 2, the compute cluster 201 may be considered asymmetric, in that the cores within the compute cluster are not all identical. Providing an asymmetric compute cluster enables the microcontroller to conform to ASIL-B and ASIL-D safety standards in a flexible and efficient manner. As previously explained, there are a number of use-case scenarios in which some vector processing tasks are safety critical, and therefore must be processed in compliance with ASIL-D by using dual-core lockstep processing. Nonetheless, it is noted that in the same use-case scenarios, many other vector processing tasks are not safety critical and are merely required to be ASIL-B compliant, which does not necessitate dual-core lockstep processing. A more significant number of scalar processing tasks are safety critical, and so require ASIL-D compliance.

ASIL-D compliance is achievable using dual-core lockstep processing, wherein two cores are paired in a lockstep mode to form a lockstep pair. A second core (known as a checker core) of the pair duplicates all the work performed by the first core in the pair. The outputs of each core are compared, with any discrepancies indicating that an error has occurred. This pairing of cores may be achieved through software configuration. The present disclosure recognizes that carefully selecting which cores to pair is able to improve the performance of the microcontroller.

In an example, microcontroller 200 of FIG. 2 is required to perform two vector processing tasks in compliance with ASIL-B and two scalar processing tasks in compliance with ASIL-D. To achieve ASIL-D compliance, at least two of the cores will need to form a lockstep pair to perform the scalar processing tasks. Preferably, the four cores will be split into two lockstep pairs, such that each lockstep pair may be used to process a different one of the scalar processing tasks at the same time.

In the case of exemplary microcontroller 200, there are two basic options for the lockstep pairs—mixed pairs, in which each pair contains one core having a vector extension and one core without a vector extension; or unmixed pairs in which one pair contains two cores having vector extensions and the other pair contains two cores without vector extensions. Irrespective of whether the pairs are mixed or unmixed, they will both support lockstep scalar processing because every core in microcontroller 200 contains a scalar extension. However, the mixed pairs will not support lockstep vector processing because only one core in each mixed pair contains a vector extension.

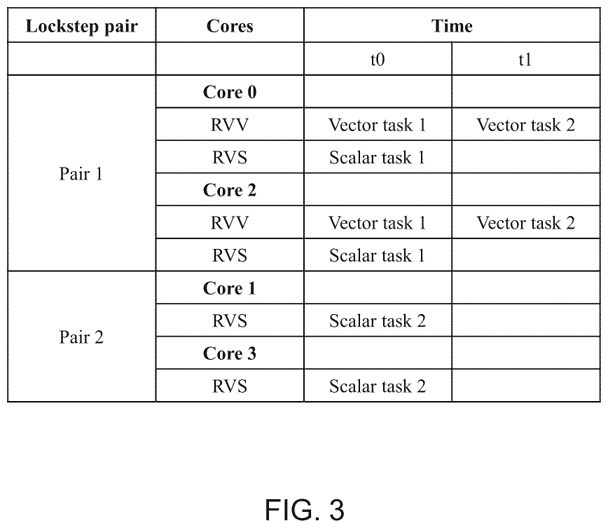

FIG. 3 is a simple scheduling chart showing the time needed to process all four tasks using unmixed pairs. Pair 1 is the lockstep pair consisting of the two vector-capable cores (core 0 210 and core 2 230) while pair 2 is the lockstep pair consisting of the two remaining cores that do not contain vector extensions (core 1 220 and core 3 240).

In time period 0 (t0), the scalar extensions of pair 1 are each used to process scalar task 1. The outputs of the two cores are then compared to determine whether they contain any differences. At the same time (that is, also within t0), the scalar extensions of pair 2 are each used to process scalar task 2 and their outputs are also compared. In this way, the two scalar tasks may be processed in compliance with ASIL-D within t0.

During t0, the vector extension 211 of core 0 210 is used to process vector task 1. However, due to the lockstep pairing of core 0 210 with core 2 230, the vector extension 231 of core 2 is unable to process vector task 2. Instead, vector extension 231 is forced to act as a checker core, duplicating the work of core 0 210 by processing vector task 1. In other words, the lockstep pairing of core 0 210 and core 2 230 halves the effective vector processing power of the microcontroller by preventing the two vector extensions from processing different vector tasks at the same time. For this reason, vector task 2 is may only be processed in a second time period (t1), after vector task 1 has been completed.

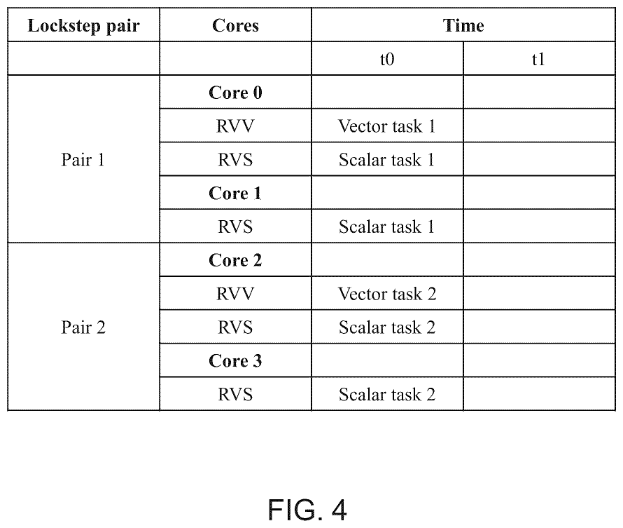

FIG. 4 shows the scheduling of tasks in an alternative example in which each lockstep pair is a mixed pair. As with the example of FIG. 3, in this example the two scalar extensions of pair 1 operate in parallel to process scalar task 1 using dual-core lockstep processing, and the two scalar extensions of pair 2 operate in parallel to process scalar task 2 using dual-core lockstep processing. In this way, the two scalar tasks are again processed in t0. However, unlike in the example of FIG. 3, each lockstep pair now contains only one vector extension. This means that the vector processing capacity of core 2 230 (now in lockstep pair 2) is unable to be consumed by duplicating the work performed by the vector extension of core 0 210 (in lockstep pair 1). Accordingly, lockstep pair 1 is able to process vector task 1 to the required ASIL-B standard while lockstep pair 2 processes vector task 2 to the ASIL-B standard. By configuring the lockstep pairs such that the two vector-capable cores are separated, the four tasks may be processed in less time while still conforming to the required safety standards.

In (relatively) rare cases where vector processing is required to conform to the ASIL-D standard, at least one lockstep pair will be required to contain two vector extensions (that is, two cores each containing at least one vector extension). Accordingly, the compute cluster may be reconfigured to provide unmixed lockstep pairs when needed.

The previously described microcontroller comprises only four cores. However, in other examples, the microcontroller might contain more than four cores or less than four cores. Most generally, the microcontroller contains at least two cores, and at least one of the cores contains a vector extension and a scalar extension while at least another one of the cores contains a scalar extension but does not contain a vector extension.

In some examples, the microcontroller contains eight cores. The microcontroller may contain an even number of cores having vector extensions (such as in the example of FIG. 2) or may contain an uneven number of cores having vector extensions. For example, the microcontroller may contain eight cores having scalar extensions, with exactly two or four or six of the cores also having vector extensions. In other examples, the microcontroller may contain eight cores having scalar extensions, with exactly one or three or five or seven of the cores also having vector extensions.

In some examples, a microcontroller contains at least two cores that include vector extensions, to provide the potential for lockstep vector processing. However, in other examples the microcontroller may contain only one core having a vector extension. For example, the microcontroller may contain four cores having a scalar extension, with only one of those cores also having a vector extension.

As mentioned above, the microcontroller may be configured, using software, to form lockstep pairs. For this reason, the configuring of the cores into lockstep pairs is both adaptable and reversible. Cores may be paired to create lockstep pairs for processing a first set of tasks, and subsequently unpaired once the tasks are completed. The cores may then be paired again in a different configuration. For example, the unmixed pairs of FIG. 3 may be reconfigured into the mixed pairs of FIG. 4 (or vice versa) in response to the tasks to be processed.

In examples in which the microcontroller contains six or more cores, the microcontroller may be configured to form at least three different types of lockstep pair:
a. a first lockstep pair, in which one core contains a vector extension and a scalar extension, and one core contains a scalar extension and does not contain a vector extension;
b. a second lockstep pair, in which each core contains a scalar extension and neither core contains a vector extension; and
c. a third lockstep pair, in which each contains both a scalar extension and a vector extension.

This configuration of lockstep pairs helps to provide a balance between the ability to perform ASIL-D vector processing and the desire to improve (e.g., maximize) the vector processing output of the microcontroller.

In the example of FIG. 2, compute cluster 201 contained shared components 260-265 that were connected to the cores via cluster interconnect 250. However, in some examples, one or more of components 260-265 might not be shared by some or all the cores. In some examples, the cluster interconnect may simply connect the cores to each other, and optionally connect each core to external memory 270.

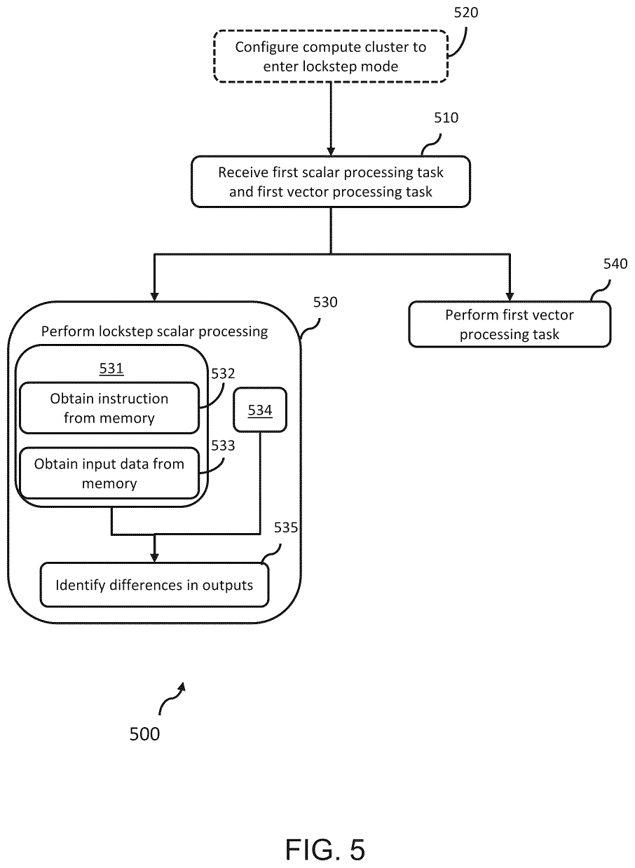

With reference to FIG. 5, an exemplary method 500 performed by microcontroller 200 will now be described in greater detail.

In step 510, the core 0 210 receives a first scalar processing task and a first vector processing task. These tasks may be received from external memory 270 or may be received over a network via a network adapter. Receiving the tasks may comprise storing input data for the task and storing task instructions in memory 213. The first scalar processing task is a safety critical task, and therefore must be processed in compliance with ASIL-D. The first vector processing task is not safety critical and need only be processed in compliance with ASIL-B.

In some examples, the method 500 comprises a step 520 of configuring the compute cluster 201 of microcontroller 200 to enter lockstep mode. In the lockstep mode, core 0 210 is paired with core 1 220 to form a lockstep pair.

Step 520 may, for instance, be performed on booting of the microcontroller (e.g., of each core). The firmware executing upon booting may be configured to perform step 520.

In step 530, the lockstep pair performs lockstep scalar processing to process the first scalar processing task.

In the present example, the first scalar processing task includes an indication of the ASIL requirement of the task. On receiving the task, core 0 210 detects the indication of the ASIL requirement and, in response, configures the compute cluster to enter lockstep mode. Examples of an indication of an ASIL requirement include a flag, and/or an explicit instruction to enter lockstep mode.

In some examples, the compute cluster 201 may contain a controller unit that is connected to cluster interconnect 250 and is used to configure the compute cluster 201 to enter lockstep mode. The controller may obtain the first scalar processing task from memory 270 and pass the task to core 0 210, as well as configuring compute cluster 201 to enter lockstep mode.

In step 531, the scalar extension 212 of core 0 performs the first scalar processing task. This comprises obtaining 532 an instruction to perform the first scalar processing task from memory 213 and obtaining 533 input data for the first scalar processing task from memory 213. Memory 213 is located within core 0 and is directly accessible by vector extension 211 and scalar extension 212 but is not directly accessible by the extensions of any other core. Memory 213 may be a single memory device or may be more than one memory device. For example, memory 213 may comprise an “Instruction closely coupled memory” (ICCM) or an instruction cache, configured to store scalar processing instructions and vector processing instructions, and a “Data closely coupled memory” (DCCM) or data cache, configured to store input data for scalar processing tasks and input data for vector processing tasks.

Core 1 220, which acts as the checker core in the lockstep pair, also performs 534 the first scalar processing task. In the present example the two cores operate in parallel, meaning that core 0 210 and core 1 220 are each used independently to process the first scalar processing task at the same time. In some examples, the two cores may operate with a time offset. For example, core 1 might only start performing the first scalar processing task after core 0 has started performing the first scalar processing task, and optionally only after core 0 has finished performing the first scalar processing task.

While not shown in FIG. 5, core 1 220 may perform 534 the first scalar processing task using its memory 223 in the same way as core 0 210.

In step 535, the outputs of the scalar processing task generated by core 0 210 and core 1 220 are compared to determine whether any differences are present in the outputs. Differences in the outputs indicate that an error has occurred and may trigger error mitigation procedures.

In step 540, the vector extension 211 of core 0 210 performs the first vector processing task. This may be performed before, at the same time, or after the scalar extension 212 of core 0 210 is performing the first scalar processing task.

While not shown in FIG. 5, a second lockstep pair (consisting of core 2 230 and core 3 240) may perform a corresponding method to perform other scalar processing tasks and vector processing tasks, in parallel to the operation of the first lockstep pair.

In some examples, the method need not comprise steps 532 and 533. For example, core 0 210 may process the input data and instructions obtained from external memory 270 without caching the data and instructions in memory 213. Alternatively, the core may cache the data and instructions in shared cluster cache 261 or shared cluster memory.

In some aspects, a computer program is provided that comprises computer readable code configured to cause a computer system to perform a method as described above when the code is run on the computer system. The computer program may be stored on a computer readable storage medium. The computer readable storage medium may be a non-transitory computer readable storage medium.

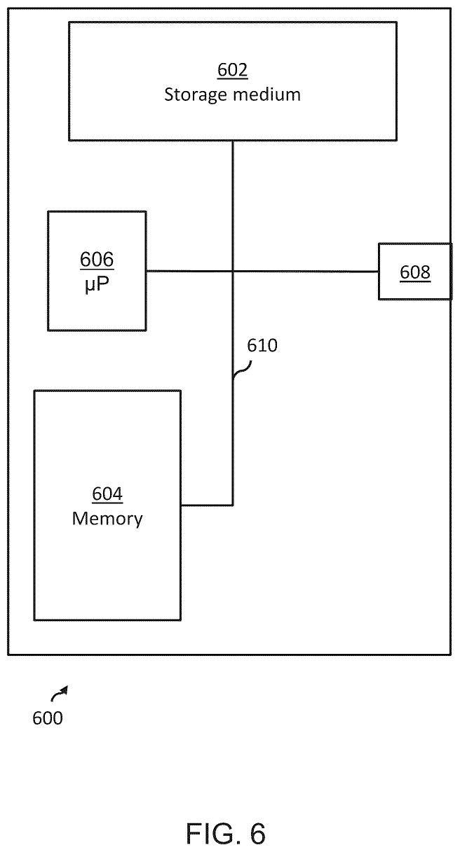

FIG. 6 illustrates an exemplary computer system 600 upon which such a computer program may run. The exemplary computer system 600 comprises a computer-readable storage medium 602, a memory 604, a processor 606 and one or more interfaces 608, which are all linked together over one or more communication busses 610. Processor 606 may be implemented as a microcontroller comprising a compute cluster as described in the examples above, or processor 606 may be implemented as a compute cluster as described in the examples above and the processor 606 and memory 604 may together form a microcontroller.

The computer-readable storage medium 602 and/or the memory 604 may store one or more computer programs (or software or code) and/or data (including but not limited to input data for scalar processing tasks and input data for vector processing tasks). The computer programs stored in the computer-readable storage medium 602 and/or the memory 604 may include computer programs that, when executed by the processor 606, cause the processor 606 to carry out a method as described above. The computer-readable storage medium 602 and/or the memory 604 may be a non-transitory computer readable storage medium. The computer-readable storage medium 602 and/or the memory 604 may be one or more memory chips or memory blocks implemented within the processor or may be external to the processor. The computer-readable storage medium 602 may be a removable memory device. For example, magnetic media such as a hard disk or a floppy disk, optical media such as a DVD or CD, or a USB flash drive.

As part of the execution of one or more computer-readable program instructions, the processor 606 may store data to and/or read data from the computer readable storage medium 602 and/or the memory 604. The processor 606 may, as part of the execution of one or more computer readable program instructions, store data to and/or read data from the computer-readable storage medium 602 and/or the memory 604.

The one or more interfaces 608 may comprise a network interface enabling the computer system 600 to communicate with other computer systems across a network. In some examples, the computer system 600 may obtain scalar processing tasks and/or vector processing tasks via the network. The network may be any kind of network suitable for transmitting or communicating data from one computer system to another. For example, the network could comprise one or more of a local area network, a wide area network, a metropolitan area network, the internet, a wireless communications network, and so on. The computer system 100 may communicate with other computer systems over the network via any suitable communication mechanism/protocol. The processor 606 may communicate with the network interface via the one or more communication buses 610 to cause the network interface to send data and/or commands to another computer system over the network. Similarly, the one or more communication buses 610 enable the processor 606 to operate on data and/or commands received by the computer system 600 via the network interface from other computer systems over the network.

While various aspects described herein may be illustrated and described as block diagrams, it is well understood that these blocks may be implemented in, as non-limiting examples, hardware, software, firmware, special purpose circuits or logic, general purpose hardware or controller or other computing devices, or some combination thereof.

A single unit described above may fulfill the functions of several items recited in the claims. A computer program may be stored/distributed on a suitable medium, such as an optical storage medium or a solid-state medium supplied together with or as part of other hardware, but may also be distributed in other forms, such as via the Internet or other wired or wireless telecommunication systems.

Although specific examples have been illustrated and described herein, it will be appreciated by those of ordinary skill in the art that a variety of alternate and/or equivalent implementations may be substituted for the specific examples shown and described without departing from the scope of the present invention. This application is intended to cover any adaptations or variations of the specific examples discussed herein. Therefore, it is intended that this invention be limited only by the claims and the equivalents thereof.

It should be noted that the methods and devices including its preferred embodiments as outlined in the present document may be used stand-alone or in combination with the other methods and devices disclosed in this document. In addition, the features outlined in the context of a device are also applicable to a corresponding method, and vice versa. Furthermore, all aspects of the methods and devices outlined in the present document may be arbitrarily combined. In particular, the features of the claims may be combined with one another in an arbitrary manner.

It should be noted that the description and drawings merely illustrate the principles of the proposed methods and systems. Those skilled in the art will be able to implement various arrangements that, although not explicitly described or shown herein, embody the principles of the invention and are included within its spirit and scope. Furthermore, all examples and embodiments outlined in the present document are principally intended expressly to be only for explanatory purposes to help the reader in understanding the principles of the proposed methods and systems. Furthermore, all statements herein providing principles, aspects, and embodiments of the invention, as well as specific examples thereof, are intended to encompass equivalents thereof.

1. A microcontroller comprising a compute cluster, the compute cluster comprising a plurality of RISC-V cores, wherein:
the plurality of RISC-V cores comprises at least a first core and a second core;
the first core comprises a first scalar extension for performing scalar processing tasks and a first vector extension for performing vector processing tasks;
the second core comprises a second scalar extension for performing scalar processing tasks;
the second core comprises no vector extensions;
the first core comprises a memory directly accessible by the first scalar extension and the first vector extension, but not directly accessible by the second core; and
the compute cluster comprises an interconnect that connects each core of the plurality of RISC-V cores.

2. The microcontroller of claim 1, wherein the memory comprises one or more of:
an instruction cache, configured to store instructions for scalar processing tasks and instructions for vector processing tasks;
a data cache, configured to store input data for scalar processing tasks and input data for vector processing tasks;
an instruction closely coupled memory, configured to store instructions for scalar processing tasks and instructions for vector processing tasks; or
a data closely coupled memory, configured to store input data for scalar processing tasks and input data for vector processing tasks, wherein:
the scalar extension is configured to obtain input data for scalar processing tasks and the vector extension is configured to obtain input data for vector processing tasks from the data cache and/or the data core coupled memory;
the scalar extension is configured to obtain instructions for scalar processing tasks and the vector extension is configured to obtain instructions for vector processing tasks from the instruction cache and/or the instruction core coupled memory.

3. The microcontroller of claim 1, wherein:
the compute cluster comprises one or more of:
a shared core coupled memory target port, connected to each of the plurality of RISC-V cores via the cluster interconnect;
a shared cluster cache, accessible by each of the plurality of RISC-V cores via the cluster interconnect;
a shared cluster memory, accessible by each of the plurality of RISC-V cores via the cluster interconnect;
a shared direct memory access unit, accessible by each of the plurality of RISC-V cores via the cluster interconnect;
a shared CPU initiator port, connected to each of the plurality of RISC-V cores via the cluster interconnect; and
a shared core infrastructure, comprising one or more of a power management unit, a interrupt distribution unit, a safety management unit, a debug unit and a trace unit.

4. The microcontroller of claim 1, wherein the compute cluster is configurable to enter a lockstep mode in which the first core and the second core form a first lockstep pair, wherein the first lockstep pair supports lockstep scalar processing but does not support lockstep vector processing.

5. The microcontroller of claim 4, wherein, in the lockstep mode, the first lockstep pair is configured to perform lockstep scalar processing in compliance with the ASIL-D standard and vector processing in compliance with the ASIL-B standard.

6. The microcontroller of claim 4, wherein the compute cluster further comprises:
a third core; and
a fourth core,
wherein:
the third core and the fourth core each comprise a scalar extension for performing scalar processing tasks;
neither the third core nor the fourth core comprise a vector extension;
when the compute cluster is in the lockstep mode, the third core and the fourth core form a second lockstep pair; and
the second lockstep pair supports lockstep scalar processing but does not support lockstep vector processing.

7. The microcontroller of claim 4, wherein the compute cluster further comprises:
a fifth core; and
a sixth core,
wherein:
the fifth core and the sixth core each comprise a scalar extension for performing scalar processing tasks;
the fifth core and the sixth core each comprise a vector extension for performing vector processing tasks;
when the compute cluster is in the lockstep mode, the fifth core and the sixth core form a third lockstep pair; and
the third lockstep pair supports lockstep scalar processing and lockstep vector processing.

8. The microcontroller of claim 1, wherein an even number of cores of the plurality of RISC-V cores comprise vector extensions.

9. A computer-implemented method of performing scalar processing tasks and vector processing tasks using a microcontroller, the microcontroller comprising a compute cluster, the compute cluster comprising a plurality of RISC-V cores, wherein:
the plurality of RISC-V cores comprises at least a first core and a second core;
the first core comprises a first scalar extension for performing scalar processing tasks and a first vector extension for performing vector processing tasks;
the second core comprises a second scalar extension for performing scalar processing tasks;
the second core comprises no vector extensions;
the first core comprises a memory directly accessible by the first scalar extension and the first vector extension, but not directly accessible by the second core; and
the compute cluster comprises an interconnect that connects the plurality of RISC-V cores, the method comprising:
receiving, by the first core, a first scalar processing task and a first vector processing task;
performing, by the first scalar extension, the first scalar processing task; and
performing, by the first vector extension, the first vector processing task.

10. The method of claim 9, wherein performing the first scalar processing task and the first vector processing task comprises at least one of:
obtaining, by the first scalar extension from the memory, an instruction to perform the first scalar processing task, and obtaining, by the first vector extension from the memory, an instruction to perform the first vector processing task; and
obtaining, by the first scalar extension from the memory, input data to be processed in the first scalar processing task, and obtaining, by the first vector extension from the memory, input data to be processed in the first vector processing task.

11. The method of claim 9, further comprising:
configuring the compute cluster to enter a lockstep mode in which the first core and the second core form a first lockstep pair;
performing, by the first lockstep pair, lockstep scalar processing, wherein the lockstep scalar processing comprises:
performing, by the first scalar extension, the first scalar processing task;
performing, by the second scalar extension, the first scalar processing task; and
identifying whether any difference exists between the output of the first scalar processing task produced by the first scalar extension and the output of the first scalar processing task produced by the second scalar extension; and
performing, by the first vector extension while the compute cluster is in the lockstep mode, the first vector processing task, wherein the first vector processing task is not performed as a lockstep vector processing task.

12. The method of claim 11, wherein the configuring of the compute cluster is performed based on a set of tasks being processed by the compute cluster.

13. The method of claim 11, wherein the configuring of the compute cluster is performed based on a safety requirement associated with at least one of a set of tasks being processed by the compute cluster.

14. The method of claim 13, comprising determining the safety requirement based on an indication associated with the first scalar processing task or the first vector processing task.

15. The method of claim 11, comprising, after processing the first vector processing task and the first scalar processing task, re-configuring the compute cluster to enter a non-lockstep mode in which the first core and the second core are not a lockstep pair based on a safety requirement associated with a second of a set of tasks being processed by the compute cluster.

16. The method of claim 15, comprising determining the safety requirement based on an indication associated with the second set of tasks.

17. A compute cluster, comprising:
a first RISC-V core that includes a first scalar extension and a first vector extension;
a second RISC-V core that includes a second scalar extension and does not include a vector extension;
a third RISC-V core that includes a third scalar extension and a third vector extension; and
a controller unit configured to configure the first RISC-V core and the second RISC-V core to enter lockstep mode based on a first scalar processing task to be processed by the first RISC-V core and the second RISC-V core.

18. The compute cluster of claim 17, wherein the controller unit is configured to configure the first RISC-V core and the second RISC-V core to enter lockstep mode based on a safety requirement associated with the first scalar processing task.

19. The compute cluster of claim 17, wherein the controller unit is configured to configure the first RISC-V core and the third RISC-V core to enter lockstep mode based on a second processing task.

20. The compute cluster of claim 17, wherein the controller unit comprises one of the first RISC-V core, the second RISC-V core, or the third RISC-V core.
